(19) United States
(12) Patent Application Publication
(10) Pub. No.: US 2005/0223864 A1
(43) Pub. Date: Oct. 13, 2005

(54) Cutting wheel and apparatus for cutting a food product

(75) Inventor: Mark Van Hemelrijk, Aartselaar (BE)

Correspondence Address: SUGHRUE MION, PLLC, 2100 PENNSYLVANIA AVENUE, N.W., SUITE 800, WASHINGTON, DC, 20037, US

(73) Assignee: FAM

(21) Appl. No.: 10/831,360

(22) Filed: Apr. 26, 2004

(30) Foreign Application Priority Data
Apr. 9, 2004 (EP) 04447094.6

(51) Int. Cl. B26D 1/14

(52) U.S. Cl. 83/592; 83/932

(57) ABSTRACT

A cutting wheel (1) which is provided for being rotatably mounted on an apparatus (100) for cutting food products, the cutting wheel (1) comprising a plurality of oblong cutting elements (10; 40) extending radially between a hub (2) and an outer rim (3) of the cutting wheel. Each cutting element (10; 40) comprises a main cutting knife (11) having a front side (12) with a main cutting edge (13) directed to the forwards rotation direction (5) of the cutting wheel (1) and a plurality of additional cutting knives (14-17; 41-42) mounted in an angle on a side (18) of the main cutting knife (11) opposite from where the food products are fed. Each of the additional cutting knives (14-17; 41-42) has a front side (24-25; 43-44) with an additional cutting edge (34-35; 45-46) directed towards the front side (12) of the main cutting knife (11). For each two successive additional cutting knives (14-15; 41-42) of each cutting element (10; 40) there is a predetermined difference between a first distance (D1; D5), measured from the main cutting edge (13) to the additional cutting edge (34; 45) of a first cutting knife (14; 41) of the two, and a second distance (D2; D6), measured from the main cutting edge (13) to the additional cutting edge (35; 46) of a second cutting knife (15; 42) of the two.

The present invention relates to a cutting wheel provided for being rotatably mounted on an apparatus for cutting a food product according to the preamble of claim 1.

U.S. Pat. No. B2-6,460,444 relates to an apparatus for cutting a food product, comprising a cutting wheel having a plurality of radially extending cutting elements. Each cutting element comprises a main knife on which additional cutting knives are fixed to produce a multi-dimensional cut of the food product. The additional cutting knives are attached to each of the main knives of the cutting wheel so as to extend approximately at right angles to the cutting plane defined by the main knives. For each cutting element, the cutting edges of the additional cutting knives are all positioned at the same distance from the cutting edge of the main knife.

The cutting wheel known from U.S. Pat. No. B2-6,460,444 however has the disadvantage that the cut food product may become jammed between the additional cutting knives, leading to an undesired piling up of the food product.

From U.S. Pat. No. 5,619,897 and DE-B-1000577 a disc-like cutter blade for cutting food products is known. The cutter blade comprises a radially extending cutting edge which is axially offset from an upstream surface of the blade with upstanding slitter blades. These slitter blades are mounted on angularly spaced apart locations on the upstream surface of the blade. During rotation of the disc-like cutter blade, the food product to be cut first comes into contact with the slitter blades, one after the other, before being cut by the cutting edge, i.e. the slitter blades are mounted upstream from the cutting edge. Furthermore, the slitter blades produce slits into the food product without actually cutting it into pieces, so that the problem of pieces of the food product getting stuck in between successive slitter knives does not arise. As a result, there is no teaching in either of U.S. Pat. No. 5,619,897 and DE-B-1000577 which could lead the skilled person to a solution of the problem of the cutting wheel of U.S. Pat. No. B2-6,460,444.

It is an aim of the present invention to provide a cutting wheel for use in an apparatus for cutting a food product with which the risk of cut food product getting jammed can be reduced.

This aim is achieved according to the invention with a cutting wheel showing the technical characteristics of the characterising part of the first claim.

The cutting wheel of the invention comprises a plurality of radially extending cutting elements, each of which has a main cutting knife with a plurality of additional cutting knives, i.e. two or more additional cutting knives. Each main cutting knife has a front side showing a main cutting edge which is directed towards the forwards rotation direction of the cutting wheel. The additional cutting knives are mounted in an angle on a side of the main cutting knife opposite the side from which the food product to be cut is fed to the cutting wheel. In other words, the food product is first cut by the main cutting knives and then by the additional cutting knives. The additional cutting knives have front sides with additional cutting edges directed towards the front side of the main cutting knife. For each two successive additional cutting elements, there is a predetermined difference in their positions with respect to the main cutting edge: a first of the two additional cutting knives is mounted with its additional cutting edge at a first distance from the main cutting edge and a second of the two additional cutting knives is mounted with its additional cutting edge at a second, different distance from the main cutting edge. According to the invention, this criterion is applicable to each two successive additional cutting knives of each cutting element, whatever the number of additional cutting knives on the element and whichever two successive additional cutting knives are considered.

An analysis of the problem of the prior art cutting wheel has shown that the cut food product gets jammed between the additional cutting knives as a result of their thickness, which increases from the cutting edge at the front towards the back. Due to this increasing thickness, the space between successive knives decreases from front to back. As a result, the additional cutting knives act as a clamp on the cut food product moving from front to back.

With the cutting wheel of the invention, successive additional cutting knives are placed with their cutting edges at different distances from the main cutting edge. As a result, after having been cut by the main cutting edge, the food product is first cut by the foremost cutting knife or knives, before being cut by the more backwards mounted cutting knife or knives. As a result, the cutting of the food product by the additional cutting knives is divided up into at least two stages and the food product does not reach all the additional cutting knives at once. This reduces the clamping effect of the additional cutting knives on the food product and thus the risk that this becomes jammed between the additional knives of the cutting wheel of the invention.

Furthermore, because of the difference in their distances to the main cutting edge, the successive additional cutting knives can be mounted closer to each other with respect to the additional cutting knives of the prior art cutting wheel. As a result, the cutting elements of the cutting wheel of the invention can carry more additional cutting knives than the prior art cutting wheel. This has the advantage that food products can be cut to a larger extent, i.e. into smaller pieces with respect to the prior art. Furthermore, this can avoid the need for an additional knife upstream of the cutting wheel for pre-cutting the food products as in the prior art in order to finally achieve pieces of limited size.

In a preferred embodiment of the cutting wheel of the invention, at least one of the cutting elements comprises a series of front and back additional knives alternating with each other. This means that the cutting element has more frontally mounted additional cutting knives at a shorter distance from the main cutting edge alternating with more backwards mounted additional cutting knives at a longer distance from the main cutting edge.

In another preferred embodiment, at least one of the cutting elements comprises a succession of additional cutting knives of which the distance between the main cutting edge and the respective additional cutting edge increases from the hub towards the outer rim of the cutting wheel. This means that the cutting element has a series of additional cutting knives of which the innermost, i.e. the one closest to the hub, is mounted at the shortest distance from the main cutting edge and the outermost, i.e. the one furthest from the hub, is mounted at the longest distance from the main cutting edge. Additional cutting knives in between the innermost and outermost knives are mounted at intermediate distances from the main cutting edge, in such a way that the distance to the main cutting edge gradually increases towards the outer rim of the cutting wheel.

The invention will be further elucidated by means of the following description and the appended figures.

FIG. 1 shows a first preferred embodiment of a cutting element of the cutting wheel of the invention.

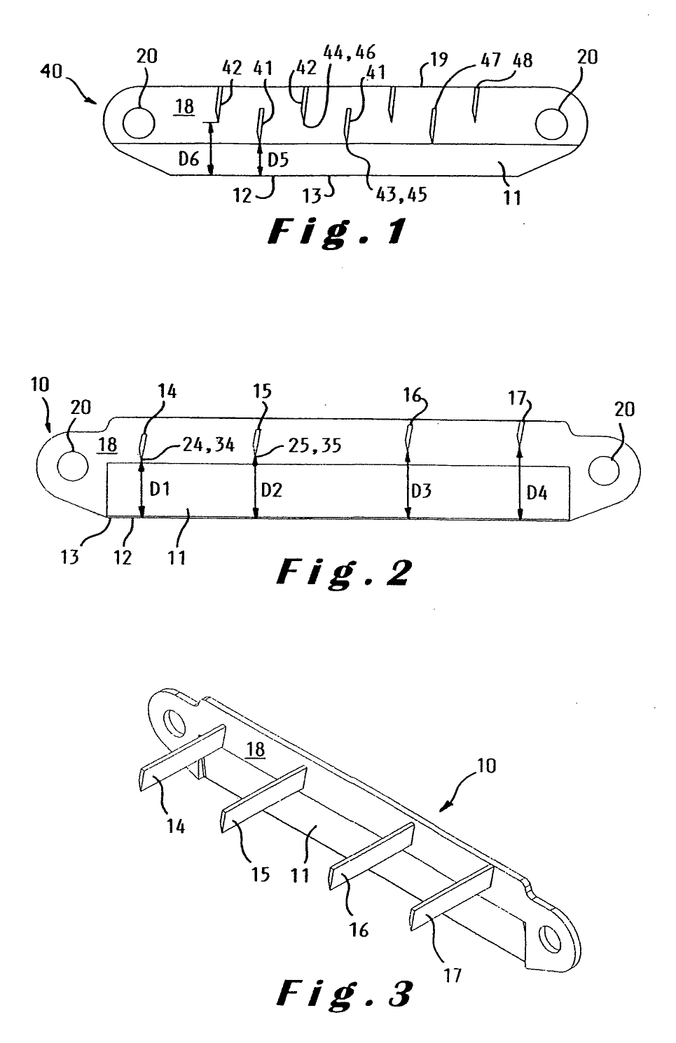

FIGS. 2 and 3 show a second preferred embodiment of a cutting element of the cutting wheel of the invention.

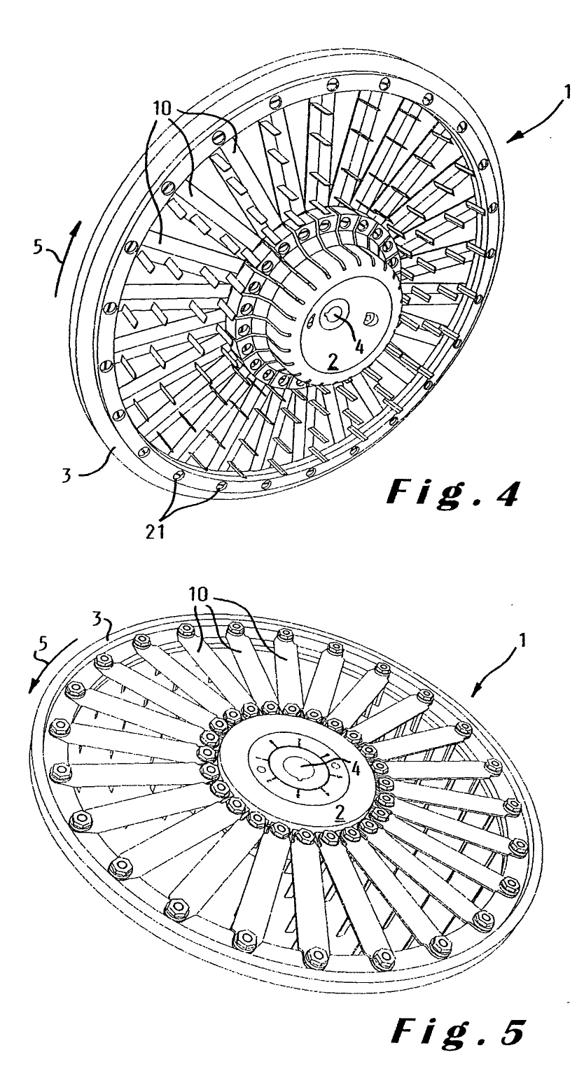

FIGS. 4 and 5 show the cutting wheel of the invention equipped with cutting elements as shown in FIGS. 2 and 3.

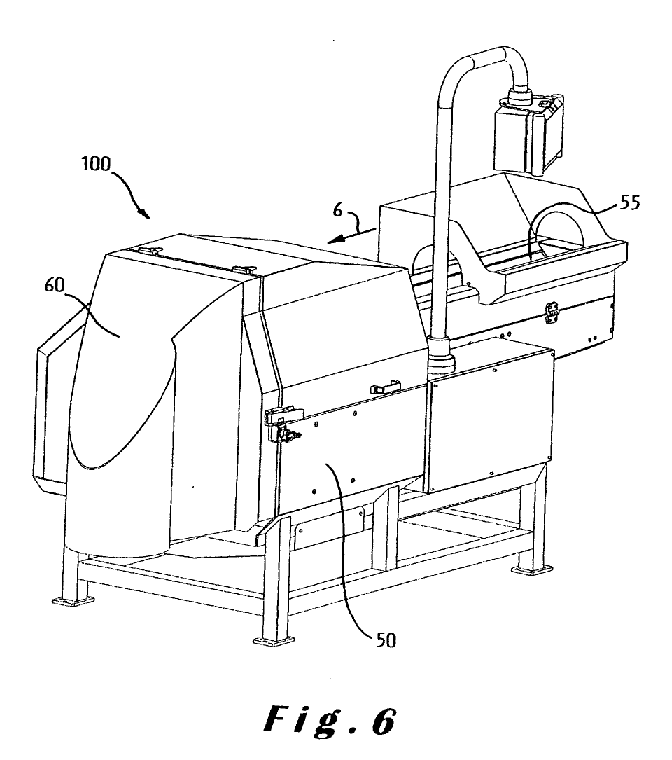

FIG. 6 shows the apparatus for cutting a food product for which the cutting wheel of FIGS. 4 and 5 is intended.

The cutting wheel 1 illustrated in FIGS. 4 and 5 comprises a hub 2 and an outer rim 3 interconnected by a plurality of cutting elements 10, which extend in radial direction of the cutting wheel 1. In use, the cutting wheel is rotated about an axis 4 in the direction of arrow 5. The cutting elements 10 comprise main knives 11 whose front edges 12 face the forwards rotation direction and are provided with sharpened cutting edges 13. The cutting elements 10 further comprise two or more additional or so-called “julienne” knives 14-17 which are mounted in an angle on one side 18 of the main knives 11, more particularly the side opposite from where the food product to be cut is fed to the cutting wheel 1, so that the food product is first cut by the main knives 11 before it reaches the additional knives 14-17. The additional knives 14-17 have front edges 24-27 which are directed towards the front edge 12 of the main cutting knife 11 and are sharpened to form additional cutting edges 34-37.

According to the invention, the relative positions of the additional knives 14-17 with respect to the main cutting edge 13 is well chosen according to the following criterion: for each two successive additional cutting knives of each cutting element there is a predetermined difference between a first distance, measured from the main cutting edge to the additional cutting edge of a first cutting knife of the two, and a second distance, measured from the main cutting edge to the additional cutting edge of a second cutting knife of the two. For the embodiment of the cutting wheel 1 shown in FIGS. 4 and 5, this is clarified by means of the cutting element 10 taken alone and shown in FIGS. 2 and 3. A first pair of successive additional knives is formed by the first, innermost knife 14 and the second knife 15. The first knife 14 is mounted with its cutting edge 34 at the distance D1 from the main cutting edge 13. The second knife 15 is mounted with its cutting edge 35 at the distance D2 from the main cutting edge 13. The distance D2 is longer than the distance D1, i.e. there is a predetermined difference between the two. A second pair of successive additional knives is formed by the second knife 15 and a third knife 16, which is next in line from the inside to the outside of the cutting wheel 1. The third knife 16 is mounted with its cutting edge 36 at the distance D3 from the main cutting edge 13. The third distance D3 is longer than the second distance D2, i.e. there is a predetermined difference between the two. A third pair of successive additional knives is formed by the third knife 16 and a fourth knife 17, which is the outermost knife 17. This fourth knife 17 is mounted with its cutting edge 37 at the fourth distance D4 from the main cutting edge 13. The fourth distance D4 is longer than the third distance D3, i.e. there is a predetermined difference between the two.

The cutting element 10 of FIGS. 2 and 3 comprises a succession of additional cutting knives 14-17 of which the distance D1-D4 between the main cutting edge 13 and the respective additional cutting edge 34-37 increases from the hub 2 towards the rim 3 of the cutting wheel 1. The criterion of the invention can however also lead to alternative configurations of the additional cutting knives 14-17. For example, in an alternative embodiment (not shown) the distances D1-D4 may also increase from the rim 3 towards the hub 2.

In the alternative embodiment shown in FIG. 1, the cutting element 40 comprises front additional knives 41 alternating with back additional knives 42. Each pair of additional knives formed by a front knife 41 and a directly preceding or following back knife 42 is a pair of successive additional knives for which the criterion of the invention is fulfilled. The front knives 41 have front edges 43 bevelled to front additional cutting edges 45 at the distance D5 from the main cutting edge 13 and the back knives 42 have front edges 44 bevelled to back additional cutting edges 46 at the distance D6 from the main cutting edge 13. The distance D6 is predeterminedly longer than the distance D5.

In the embodiment of FIG. 1, the front knives 41 of the cutting element 40 are preferably mounted with their back edges 47 close to or in the plane formed by the back additional cutting edges 46. In this way, the risk of food product becoming jammed between a front knife 41 and a back knife 42 can be brought close to zero. The back edges 48 of the back knives 42 are preferably flush with the back edge 19 of the main knife 11.

The additional knives 14-17, 41-42 are preferably attached to the main knives 11 by brazing or the like, so that the cutting elements 10, 40 are in fact single-piece elements. As illustrated in FIGS. 1 and 2, different numbers of additional or julienne knives 14-17, 41-42 may be attached to the main knives 11 depending upon the desired size of the final cut product. The additional knives 14-17, 41-42 are preferably mounted approximately perpendicular to the main knives 11, but other angles are possible. The main knives 11 are at their ends provided with holes 20 which are provided to receive bolts 21 on the rim 3 and the hub 2, by means of which the cutting elements 10, 40 are fixed to the cutting wheel 1.

For both embodiments 10, 40 shown in FIGS. 1 and 2, the additional cutting knives 14-17, 41-42 extend in such an angle with respect to the radial direction of the cutting wheel 1 that the bisector of each additional cutting edge 34-37, 45-46 is substantially tangent to a circle defined by the additional cutting edge 34-37, 45-46 during rotation of the cutting wheel 1. This orientation of the additional knives 14-17, 41-42 compensates for their physical thickness and can further reduce the risk of food product getting jammed.

The cutting wheel 1 of FIGS. 4 and 5 is intended for being mounted in a cutting space underneath a removable cap 60 of the apparatus 100 shown in FIG. 6. This cutting apparatus 100 comprises a support structure 50 which rotatably supports the cutting wheel 1. The cutting wheel 1 rotates about axis 4 by a connection to a drive motor (not shown) which is preferably used to only drive the cutting wheel 1. The food product is conveyed in the direction of arrow 6 by conveyor 55 towards the cutting space underneath the cap 60, where the cutting wheel 1 is vertically mounted. The conveyor 55 preferably has a separate drive motor (not shown). The conveyor 55 may be either a double endless belt, V-shaped conveyor, or a flat endless conveyor belt or any other conveyor known to the person skilled in the art.

Optionally, one or more pre-cutting knives such as for example a circular slicing knife (not shown) may be mounted upstream from the cutting wheel 1 for reducing the size of the food product to be cut to a size suitable for being supplied to the cutting wheel 1. It is also possible to utilise a plurality of circular knives (not shown) to impart a plurality of longitudinal cuts to the food product before it is supplied to the cutting space underneath the cap 60. These additional upstream knives are known in the art and will therefore not be described in further detail here. None of these additional knives upstream from the cutting wheel 1 is essential for good operation of the apparatus 100.

In order to prevent deflection or deformation of the large cutting wheel 1, a rim stabilizer (not shown) may be provided for engaging the cutting wheel rim 3 to prevent any deflection of the rim, which may in turn cause deflection of the cutting elements 10, 40 as the cutting wheel rotates. Such a rim stabilizer is also not essential for good operation and is known in the art, so it will not be described in further detail here.

1. A cutting wheel (1) which is provided for being rotatably mounted on an apparatus (100) for cutting food products, the cutting wheel (1) comprising a plurality of oblong cutting elements (10; 40) extending radially between a hub (2) and an outer rim (3) of the cutting wheel,
wherein each cutting element (10; 40) comprises a main cutting knife (11) having a front side (12) with a main cutting edge (13) directed to the forwards rotation direction (5) of the cutting wheel (1) and a plurality of additional cutting knives (14-17; 41-42) mounted in an angle on a side (18) of the main cutting knife (11) opposite from where the food products are fed,
wherein each of the additional cutting knives (14-17; 41-42) has a front side (24-25; 43-44) with an additional cutting edge (34-35; 45-46) directed towards the front side (12) of the main cutting knife (11),
wherein for each two successive additional cutting knives (14-15; 41-42) of each cutting element (10; 40) there is a predetermined difference between a first distance (D1; D5), measured from the main cutting edge (13) to the additional cutting edge (34; 45) of a first cutting knife (14; 41) of the two, and a second distance (D2; D6), measured from the main cutting edge (13) to the additional cutting edge (35; 46) of a second cutting knife (15; 42) of the two.

2. The cutting wheel of claim 1, wherein for each cutting element (10; 40) the main cutting knife (11) is substantially planar and the additional cutting knives (14-17; 41-42) are mounted substantially perpendicular to the main cutting knife (11).

3. The cutting wheel of claim 1, wherein for each cutting element (10; 40) the additional cutting knives (14-17; 41-42) extend in such an angle with respect to the radial direction of the cutting wheel (1) that the bisector of each additional cutting edge (34-35; 45-46) is tangent to a circle defined by the additional cutting edge (34-35; 45-46) during rotation of the cutting wheel.

4. The cutting wheel of claim 1, wherein each of the cutting elements (10; 40) is a unitary piece, the additional cutting knives (14-17; 41-42) being irremovably fixed to the main cutting knife (11).

5. The cutting wheel of claim 1, wherein at least one of the cutting elements (40) comprises an alternation of front and back additional cutting knives (41-42).

6. The cutting wheel of claim 5, wherein for said at least one cutting element (40) the main cutting knife (11) is substantially planar and the additional cutting knives (41-42) are mounted substantially perpendicular to the main cutting knife (11).

7. The cutting wheel of claim 5, wherein for said at least one cutting element (40) the additional cutting knives (41-42) extend in such an angle with respect to the radial direction of the cutting wheel (1) that the bisector of each additional cutting edge (45-46) is tangent to a circle defined by the additional cutting edge (45-46) during rotation of the cutting wheel.

8. The cutting wheel of claim 5, wherein said at least one cutting element (40) is a unitary piece, the additional cutting knives (41-42) being irremovably fixed to the main cutting knife (11).

9. The cutting wheel of claim 1, wherein at least one of the cutting elements (10) comprises a succession of additional cutting knives (14-17) of which the distance (D1-D4) between the main cutting edge (13) and the respective additional cutting edge (34-35) increases from the hub (2) towards the rim (3) of the cutting wheel (1).

10. The cutting wheel of claim 9, wherein for said at least one cutting element (10) the main cutting knife (11) is substantially planar and the additional cutting knives (14-17) are mounted substantially perpendicular to the main cutting knife (11).

11. The cutting wheel of claim 9, wherein for said at least one cutting element (10) the additional cutting knives (14-17) extend in such an angle with respect to the radial direction of the cutting wheel (1) that the bisector of each additional cutting edge (34-35) is tangent to a circle defined by the additional cutting edge (34-35) during rotation of the cutting wheel.

12. The cutting wheel of claim 9, wherein said at least one cutting element (10) is a unitary piece, the additional cutting knives (14-17) being irremovably fixed to the main cutting knife (11).

13. A cutting element as part of the cutting wheel according to claim 1.

14. An apparatus (100) for cutting a food product comprising a cutting wheel (1) according to claim 1.
